(19) United States
(12) Patent Application Publication
(10) Pub. No.: US 2015/0358276 A1
(43) Pub. Date: Dec. 10, 2015

(54) METHOD, APPARATUS AND SYSTEM FOR RESOLVING DOMAIN NAMES IN NETWORK

(71) Applicant: INTERNATIONAL BUSINESS MACHINES CORPORATION, Armonk, NY (US)

(72) Inventors: Tian Cheng Liu, BEIJING (CN); Baohua Yang, BEIJING (CN); Yue Zhang, BEIJING (CN); Kai Zheng, BEIJING (CN)

(21) Appl. No.: 14/722,276

(22) Filed: May 27, 2015

(30) Foreign Application Priority Data
May 28, 2014 (CN) 201410232080.3

(51) Int. Cl. H04L 29/12; H04L 29/06

(52) U.S. Cl. CPC H04L 61/1511; H04L 63/20

(57) ABSTRACT

Method, apparatus and system for resolving domain names in network. One embodiment provides a method for resolving a domain name in a network, including: receiving, at a controller associated with a switch in the network, a domain name system (DNS) request for the domain name from the switch, the DNS request initiated by a client, the controller controlling operations of the switch in the network; and controlling processing of the DNS request based on a predefined security constraint at the controller to obtain a network address corresponding to the domain name, wherein the DNS request is forwarded by the switch to the controller in response to a DNS record related to the domain name being missed in first storage at the switch. Other embodiments of the present invention provide a corresponding apparatus and system.

### CROSS-REFERENCE TO RELATED APPLICATION

This application claims the benefit of priority to Chinese Patent Application No. 201410232080.3, filed May 28, 2014, the contents of which are incorporated herein by reference.

### BACKGROUND

The present invention relates to domain names in a network. More particularly, the present invention relates to a method, apparatus and system for resolving domain names in a network in the field of network technology.

A domain name system (DNS) is used to map a domain name of a network to a corresponding network address, e.g., an Internet Protocol (IP) address. The DNS system can be regarded as a hierarchical distributed system, which allows a user to conveniently access network resources through a designated network domain name, without bothering to memorize an actual network address, for example, existing in numerical string. The procedure of mapping the domain name to a network address is referred to as domain name resolution. A traditional domain name resolution process is prone to a larger response delay and security risk.

Traditionally, a DNS request for domain name resolution issued by a client is sent to a switch in the network. The switch in turn forwards the DNS request to a local DNS server in the network. If the local DNS server stores DNS records mapping entries associated with the requested domain name, the local DNS server will return the network address to the client via the switch. Otherwise, if a relevant DNS record is missed in the local DNS server, then the local DNS server forwards the DNS request to one or more DNS servers in higher level. A corresponding network address determined by higher-level DNS server(s) is returned downward level-by-level, and finally provided to the client by the switch.

In the above traditional domain name resolution process, buffering poisoning might occur in each level of DNS servers. In other words, the DNS records in the DNS servers are altered by a malicious party, such that a wrong mapping relationship between the domain name and the network address is recorded. As a result, what is obtained by the client is not an actual network address corresponding to the requested domain name. Since many protocols in the TCP/IP group do not provide a mechanism for verifying the source and/or destination of the message, the malicious party might be disguised as a DNS server to return a wrong network address and/or other information, for example, spam information, virus, or Trojan, to the client. This is called “spoof attach.” Another potential risk the traditional domain name resolution faces is a pressure attack. Namely, the malicious party issues a considerable amount of DNS requests in the name of the client, such that the real client receives mass response messages. It can seriously deteriorate the system performance of the client. Besides the above security risks, multi-level caching can also likely cause a greater response delay to the DNS request.

There has been a proposed solution of encrypting a DNS communication channel to enhance security. However, such solution has a higher computational complexity and maintenance cost, but a lower execution efficiency. Therefore, its application scope is limited. Another known solution is enhancing the security level of the DNS server through tools such as firewall, anti-virus software and the like. However, such solution cannot block attacks occurring on the network, such as a spoofing attack. In order to enhance the performance of the DNS domain name resolution process, a solution for node equilibrium between respective DNS servers has been proposed. However, such solution cannot effectively enhance the security of domain name resolution.

In view of the above, there is a need in the art for a more secure and efficient solution for domain name resolution.

### SUMMARY

The present invention provides a solution for resolving domain names in a network.

In one aspect, embodiments of the present invention provide a method for resolving a domain name in a network including: receiving, at a controller associated with a switch in the network, a domain name system (DNS) request for the domain name from the switch, the DNS request initiated by a client, and the controller controlling operations of the switch in the network. The method also includes controlling the processing of the DNS request based on a predefined security constraint at the controller to obtain a network address corresponding to the domain name, wherein the DNS request is forwarded by the switch to the controller in response to a DNS record related to the domain name being missed in first storage at the switch.

In another aspect, embodiments of the present invention provide an apparatus for resolving a domain name in a network, including: a DNS request receiving unit configured to receive, at a controller associated with a switch in the network, a domain name system (DNS) request for the domain name from the switch, the DNS request initiated by a client, the controller controlling operations of the switch in the network; and a DNS request processing unit configured to control processing of the DNS request based on a predefined security constraint at the controller to obtain a network address corresponding to the domain name, wherein the DNS request is forwarded by the switch to the controller in response to a DNS record related to the domain name being missed in first storage at the switch.

In yet another aspect, embodiments of the present invention provide a system for resolving a domain name in a network including: a switch configured to receive a domain name system (DNS) request from a client; a controller associated with the switch, configured to control operations of the switch in the network and including the apparatus as described in the above paragraph; and at least one DNS server for determining a network address corresponding to the domain name in the case of receiving the DNS request.

It is to be understood through the depiction below that according to the embodiments of the present invention, instead of merely depending on the DNS server like in the traditional solution, the control of domain name resolution can be realized by a controller associated with a network switch. Based on the predefined security constraint at the controller, the identity of the DNS server and/or returned network address and the like can be verified. With the control capability of the controller to the switch, the switch will conform to the security constraint at the controller to forward or discard the domain name resolution result returned by the DNS server, thereby reducing the risk of attack to the client to the most possibility. Moreover, in some embodiments, use of a DNS caching mechanism at the switch and/or controller further enhances the security and reduces the response delay for the DNS request. Other features and advantages of the present invention will become more comprehensible through the depiction below.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present invention.

FIG. 1 shows an exemplary computer system/server which is applicable to implement the embodiments of the present invention.

FIG. 2 shows a schematic block diagram of a network environment in which the embodiments of the present invention can be implemented.

FIG. 3 shows a schematic flow diagram of a method for resolving a domain name in a network according to the embodiments of the present invention.

FIG. 4 shows a schematic flow diagram of a method for resolving a domain name in a network according to the embodiments of the present invention.

FIG. 5 shows a schematic block diagram of an apparatus for resolving a domain name in a network according to the embodiments of the present invention.

In respective figures, same or like reference numerals are used to represent the same or like components.

### DETAILED DESCRIPTION

Some preferable embodiments will be described in more detail with reference to the accompanying drawings, in which the preferable embodiments of the present disclosure have been illustrated. However, the present invention can be implemented in various manners, and thus should not be construed to be limited to the embodiments disclosed herein. On the contrary, those embodiments are provided for the thorough and complete understanding of the present invention, and completely conveying the scope of the present invention to those skilled in the art.

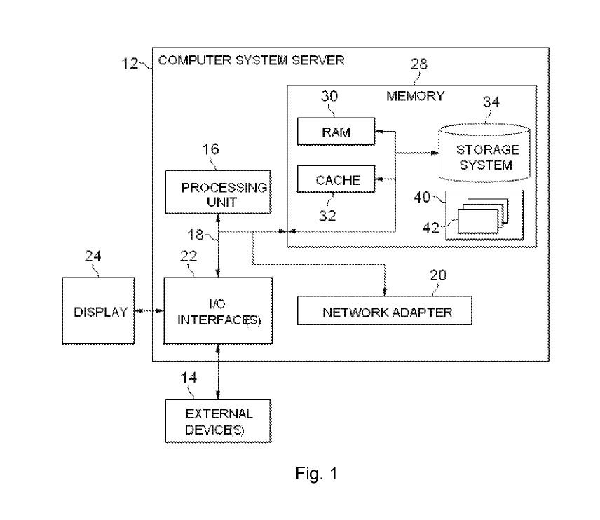

Referring to FIG. 1, an exemplary computer system/server 12 which is applicable to implement the embodiments of the present invention is shown. Computer system/server 12 is only illustrative and is not intended to suggest any limitation as to the scope of use or functionality of embodiments of the invention described herein.

Referring to FIG. 1, computer system/server 12 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media. Although not shown, a magnetic disk drive for reading from and writing to a removable, non-volatile magnetic disk, for example a “floppy disk”, and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having at least one set of program modules that are configured to carry out the functions of embodiments of the invention.

Program/utility 40, having at least one set of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network, for example the Internet, via network adapter 20. As depicted, network adapter 20 communicates with the other components of computer system/server 12 via bus 18. It should be understood that although not shown, other hardware and/or software components can be used in conjunction with computer system/server 12. Examples, include, but are not limited to: microcode, device drivers, redundant processing units, external disk drive arrays, RAID systems, tape drives, and data archival storage systems, etc.

Embodiments of the present invention will now be discussed. According to embodiments of the present invention, the domain name resolution does not merely depend on the DNS server on various levels. Rather, the control of domain name resolution can be realized by a controller associated with a network switch. Based on the predefined security constraint at the controller, the identity of the DNS server and/or returned network address and the like can be verified. With the control capability of the controller to the switch, the switch will conform to the security constraint at the controller to forward or discard the domain name resolution result returned by the DNS server, thereby reducing the risk of attack to the client as much as possible. Moreover, in some embodiments, by use of the DNS caching mechanism at the switch and/or controller, the security can be further enhanced and the response delay for the DNS request can be reduced.

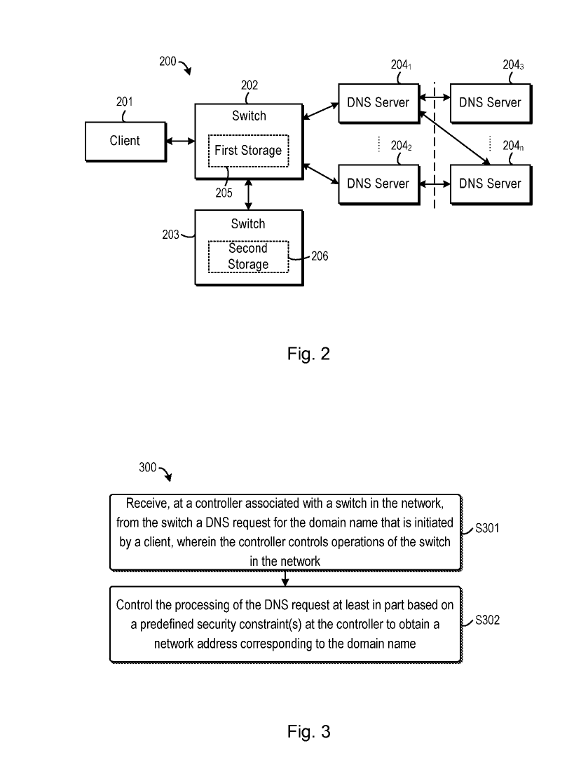

Reference is now made to FIG. 2 which illustrates a schematic block diagram of a network 200 in which the embodiments of the present invention can be implemented. The network 200 here can be any network that is subject to network domain name resolution. By way of example, the network 200 can be any wired or wireless computer network, e.g., Internet.

As shown in the figure, according to the embodiments of the present invention, a client 201 can be communicatively coupled to a switch 202. Bi-directional network communication is enabled between the client 201 and the switch 202. Although FIG. 2 only shows one switch 202, it is only for the purpose of illustration, not intended to limit the scope of the present invention. The client 201 can be coupled to more than one switch 202.

The switch 202 can be communicatively coupled to a controller 203 associated therewith. Bi-directional network communication is enabled between the switch 202 and a controller 203. According to the embodiments of the present invention, the controller 203 is for controlling various operations or actions of the associated switch 202 in the network 200. As already known, a traditional switch 202 can also perform various control functions including, routing, topological management, address resolution protocol (ARP), etc., besides performing data operations. In contrast, in the network 200 according to the embodiments of the present invention, the switch 202 can only perform the function of data plane, e.g., receiving and transmitting data packets. The controller 203 can perform control plane functions for the switch 202, e.g., managing routing, topology, ARP, etc.

By way of example, in one embodiment, the controller 203 can perform a set of applications called “SDN” (Software Defined Networking) controller. As known, the SDN controller can perform control to the switch 202. In particular, the controller 203 can also control network domain name resolution of the client 201. Embodiments in this aspect will be detailed below. Moreover, although the switch 202 and the controller 203 are shown as separate devices in FIG. 2, the scope of the present invention is not limited thereto. In some embodiments, the switch 202 and the controller 203 can be located in the same physical machine.

Still with reference to FIG. 2, in the network 200, the switch 202 can be coupled directly or indirectly to one or more DNS servers 204i . . . 204n, collectively referred to as “DNS server 204”. As used herein, the term “DNS server” refers to any private or common device that can map a network domain name to a network address (e.g., IP address). For example, the DNS server can be various kinds of DNS servers in the Internet or any evolution or variation thereof. A plurality of DNS servers can be connected in a hierarchical structure. In the example of FIG. 2, the DNS servers 204₁ and 204₂, which are local DNS servers of the switch 202₁, have a lower level; DNS servers 204₃ and 204ₙ, which are root DNS servers, have a higher level.

It should be understood that the number of DNS servers at respective levels as shown in FIG. 2 are only schematic, not intended to limit the embodiments of the present invention in any manner. Moreover, although not shown in the figure, in some embodiments, the controller 203 and one or more DNS servers 204 can likewise communicatively coupled with each other.

The client 201 can generate a DNS request for a given domain name. The domain name, for example, is input by a user through an application (e.g., Web browser) on the client 201. Alternatively or additionally, the domain name can also be automatically generated by an application on the client 201. The client 201 sends the generated DNS request to the switch 202. At this point, the switch 202 does not directly forward the DNS request to the DNS server 204 like in the traditional solution. Instead, according to the embodiments of the present invention, the switch 202 forwards the DNS request to the controller 203 associated therewith.

In some embodiments, the switch 202 can have DNS storage 205, which for the convenience of discussion is called “first storage”. A cache, buffer or any other type of memory device at the switch 202 can act as the first storage 205. In the first storage 205, there stores one or more DNS records associated with the previous DNS requests. As used herein, the term “DNS record” refers to a map entry associating a network domain name with a corresponding network address (e.g., IP address). In other words, the first storage 205 can be regarded as DNS cache at the switch 202, wherein each DNS record stores a domain name requested by the client 201 within a previous particular period of time and a network address corresponding therewith. The first storage 205 can be maintained by any currently known or future developed caching management mechanism, including, but not limited to, least recently used (LRU), most recently used (MRU), and the like.

If the switch 202 finds, in the first storage 205, a DNS record associated with the domain name indicated in the received DNS request, caching hit, then the switch 202 can directly return the corresponding network address to the client 201. At this point, the switch 202 needs not to communicate with other device in the network 200, such that the response time for the DNS request can be significantly reduced. Moreover, without extra network communication, the risk of being subject to DNS attack during network communication can be lowered. On the other hand, if a DNS record associated with a domain name indicated in the received DNS request is not found in the first storage 205, caching miss, the switch 202 can forward the DNS request to the associated controller 203.

It should be understood that the first storage 205 at the switch 202 is not a must. In alternative embodiments, the switch 202 cannot have the first storage 205, and the received DNS request is directly forwarded to the associated controller 203.

In response to reception of the DNS request from the switch 202, the controller 203 will control subsequent processing of the DNS request. Specifically, according to the embodiments of the present invention, the controller 203 controls processing of the DNS request based on a set of security constraint, to obtain a network address corresponding to the requested domain name. The term “security constraint” here refers to rules for verifying and/or processing steps, data and/or results, including intermediate results, involved in the domain name resolution procedure, so as to enhance the security. Hereinafter, several examples of the security constraint will be discussed in detail.

In some embodiments, the controller 203 can have the DNS storage 206, which for the convenience of discussion it is referred to as “second storage”. Similar to the first storage 205 as described above, the second storage 206 can also be used for caching DNS records. For example, cache, buffer, or any other type of memory at the controller 203 can act as the second storage 206. In such embodiments, the security constraint can specify that all DNS records stored in the second storage 206 should be verified as legal DNS records. For the convenience of discussion, such security constraint is referred to as “first security constraint.”

Based on the first security constraint, whether a DNS record is legal can be verified in any appropriate manner. For example, in one embodiment, the first security constraint can work in conjunction with a “black list” of the network addresses. The “black list” of network addresses is a predetermined list of malicious network addresses, which can be maintained or accessed by the controller 203. According to the first security constraint, if the controller 203 determines that one network address is included in these kind of black lists, it is prohibited to store the DNS record associated with the network address into the second storage 206.

Alternatively or additionally, in some other embodiments, the first security constraint can also be used in connection with a “white list” of network addresses. The “white list” of network addresses is a predetermined list of legal network addresses, which can be maintained or accessed by a controller 203. According to the first security constraint, when and only when a network address is included in the white list, a DNS record associated with the network address can be stored in the second storage 206.

Alternatively or additionally, the first security constraint can also control the processing of the DNS request based on keywords. For example, keywords can be one or more predefined words indicating a potential attack risk. If a network address includes one or more such keywords, it is prohibited to store a DNS record associated with the network address to second storage 206.

It should be understood that what has been described above are only several examples of the first security constraint, not intended to limit the scope of the present invention. By use of the first security constraint, all DNS records cached in the second storage 206 are verified as legal DNS records. If the controller 203 hits a DNS record related to the requested domain name in the second storage 206, the corresponding network address can be provided to the client 201 through the switch 202, thereby completing the DNS resolution securely and quickly.

In actuality, according to the embodiments of the present invention, the first security constraint can not only apply second storage 206 at the controller 203, but also apply to the first storage, if available, at the switch 202. In this way, it can be guaranteed that the cached DNS records in the first storage 205 are all legal DNS records.

Additionally, in those embodiments where there is second storage 206, another kind of security constraint can specify that the controller 203 can initiatively update cached contents in the second storage 206. For the convenience of discussion, such kind of security constraint is referred to as second security constraint. Traditionally, the DNS cache in each level of DNS servers 204 is purely updated with time. Even some or all DNS records in the DNS cache are poisoned, if the update time does not arrive, the poisoned cache contents cannot be cleared. In contrast, according to the embodiments of the present invention, the controller 203 can determine whether one or more predetermined initiative update conditions are satisfied based on the requirements of the second security constraint. In the case of yes, the DNS records cached in the second storage 206 can be initiatively and adaptively updated.

By way of example, in one embodiment, the controller 203 can determine whether one or more DNS records in the second storage 206 have been poisoned. Determination of poison can be implemented in any appropriate technical means. For example, in some embodiments, when a DNS server 204 in a network 200 is attacked or poisoned, an identification of the DNS server 204 will be provided to the controller 203. Correspondingly, the controller 203 can determine the DNS records provided by the DNS server as poisoned DNS records.

Alternatively, in some embodiments that will be described below, the controller 203 can verify a network address returned by the DNS servers 204. If the network address returned by a DNS server 204 is determined to be illegal, it can be deemed that the DNS server 204 is an untrusted DNS server. Correspondingly, all DNS records provided by the DNS server that is not trusted can be determined as poisoned DNS records.

Once it is determined that one or more DNS records in the second storage 206 have been poisoned, these DNS records can be cleared from the second storage 206. In some embodiments, in response to a determination that the DNS records have been poisoned, these poisoned DNS records can be cleared immediately. In this way, different from the traditional passive update, the controller 203 can initiatively update and merge the DNS records cached in the second storage 206, thereby enhancing the security of domain name resolution efficiently while reducing the risk of returning an illegal network address to the client 201.

Initiative update of the second storage 206 by the controller 203 facilitates completing a correct domain name resolution more quickly. For example, in a traditional domain name resolution solution, it can cost tens of minutes or even half a day to clear poisoned DNS entries. During this period, what is received by the client 201 is likely a wrong network address. However, according to the embodiments of the present invention, the poisoned DNS records can be cleared in real-time.

Moreover, by arranging and using the second storage 206 at the controller 203, the efficiency of the domain name resolution procedure can be further enhanced. Specifically, because the network communication path between the switch 202 and the controller 203 is relatively short, it does not need multiple times of relay or forwarding, such that data transmission can be completed in short enough time, e.g., less than 50 ms.

It should be understood that, similar to the first storage 205 at the switch 202, the second storage 206 at the controller 203 is also optional. In some alternative embodiments, the controller 203 might not provide a DNS caching function. In this embodiment, when the DNS request forwarded by the switch 202 is received, the controller 203 can perform domain name resolution directly using the DNS server 204.

If a relevant DNS record is missed in the second storage 206 or there is no second storage 206, the controller 203 will process the DNS request using one or more DNS servers 204 according to the security constraint. Specifically, in some embodiments, the security constraint can specify that the DNS request can only be forwarded to the verified trusted DNS servers. For the convenience of discussion, such security constraint is referred to as third security constraint.

According to the embodiments of the present invention, the trusted DNS servers are automatically pre-determined based on any criteria. For example, a list that can maintain all legally registered DNS servers in the network 200. The list of trusted DNS servers can be locally maintained at the controller 203 or alternatively maintained at any location accessible by the controller 203 in the network 200. The controller 203 can determine the trusted DNS servers by accessing the list. Alternatively, in some embodiments, the trusted DNS can also be manually input into the controller 203.

In particular, it can be understood that a trusted DNS server 204 receiving the DNS request from the controller 203 might complete the domain name resolution with the help of other higher-level DNS servers. To this end, in some embodiments, the controller 203 can send the list of trusted DNS servers, along with the DNS request, to the first-level trusted DNS server 204. In this way, it can be guaranteed that when the DNS request is forwarded between DNS servers at different levels, it will always only be sent to the trusted DNS servers. It should be understood that, it is not compulsory to send the list of trusted DNS servers along with the DNS request. On the contrary, it is only an optional implementation in some cases. When the DNS server only forwards the DNS request, for example, out of the consideration of load, the embodiments of the present invention likewise apply, because it can be at least guaranteed that the DNS server directly receiving the DNS request from the controller 203 is trusted.

Use of the third security constraint can effectively solve the issue of “spoofing attack.” The reason is that the machine used by the malicious party to pretend to be the DNS server cannot pass the verification of the network 200, because it will not be labeled as trusted DNS server. Therefore, the DNS request will never be forwarded to this faking DNS server. In this way, the malicious party's attack to the domain name resolution procedure through spoofing is effectively avoided.

Alternatively or additionally, in some embodiments, the controller 203 can verify a DNS processing result, namely, a network address corresponding to the requested domain name, returned from an external DNS server 204. For the convenience of discussion, such security constraint is referred to as “fourth security constraint.” It is to be understood that according to the embodiments of the present invention, when the controller 203 does not have the second storage 206 or a DNS record corresponding to the requested domain name is not found in the second storage 206, the domain name resolution needs to be performed with the help of an external DNS server. At this point, the DNS processing result is returned to the switch 202 by the DNS server 204. Because the controller 203 can control behaviors of the switch 202, the verification of the returned network address can be implemented. Alternatively, the DNS server 204 can also directly return the obtained network address to the controller 203 for verification.

According to the fourth security constraint, the verification of the returned network address can be completed based on any appropriate technology. For example, the technology for verifying a network address can include, but not limited to: a black list, a white list, a keyword, etc. Alternatively or additionally, in some embodiments, the DNS server 204 can be required to perform digital signature to the returned network address. Correspondingly, at the controller 203, the legality of the network address can be confirmed through verifying the digital signature. Alternatively or additionally, the verification of the network address can be performed with the DNS server 204 as a unit. Specifically, if a network address previously returned by a DNS server 204 passes the legality verification, it can be regarded that the subsequent network address returned by the DNS server 204 is likewise legal, at least within a period of time. It should be understood that the above examples are only for illustration purpose, not intended to limit the scope of the present invention. Any currently known or future developed network address verification technology can be used in combination with the embodiments of the present invention.

Additionally, the fourth security constraint can use different policies to verify the returned network address. For example, in some embodiments, the verification can be performed with the data stream as a unit. In other words, if a first data packet of a data stream passes the legality verification, the controller 203 can determine that all data packets in the data stream are legal, without bothering to verify subsequent data packets. Of course, it is also allowed to verify each data packet in the data stream.

According to the fourth security constraint, if the network address returned from the external DNS server 204 is verified to be legal network address, then the controller 203 can instruct the switch 202 to provide the network address to the client 201. Particularly, in those embodiments in which the controller 203 has the abovementioned second storage 206, the controller 203 can also generate a DNS entry associating the requested network domain name with the returned network address. The DNS entry is saved in the second storage 206 to thereby create and update the cache. Alternatively or additionally, if the switch 202 has first storage 205, the first storage can likewise be updated to create a new cache entry.

On the other hand, if the network address returned by the DNS server 204 does not pass the legality verification, then the fourth security constraint can prescribe: the controller 203 instructs the switch 202 to discard the network address. In this way, by virtue of the verification of the returned network address by the controller 203 and the control by the switch 202, the illegal network address will be blocked and filtered at the switch 202. In this way, pressure attack in the traditional domain name parsing procedure can be effectively avoided.

Moreover, in some embodiments, if the network address returned by the DNS server 204 does not pass the legality verification, then the fourth security constraint can prescribe: the controller 203 can identify the DNS server 204 providing the illegal network address to untrusted DNS server. In some embodiments, the DNS server can be directly identified untrusted. Alternatively, in other embodiments, the number of illegal network addresses returned by the DNS server 204 can be aggregated. In response to the number exceeding a predetermined threshold, the controller 203 can identify the DNS server 204 as untrusted DNS server. This facilitates identification and avoidance of potential attack from illegal DNS servers.

According to the embodiments of the present invention, in response to determining that the returned network address is illegal, the controller 203 can continue processing the DNS request in any appropriate manner. For example, in some embodiments, the controller 203 can select another trusted DNS server 204 and instruct the switch 202 to forward the DNS request to the selected DNS server 204. Alternatively, the controller 203 can also make the DNS request directly forwarded to a higher level or even the root DNS server. Any other subsequent processing actions are possible, and the scope of the present invention is not limited thereto.

FIG. 3 shows a flow diagram of a method 300 for resolving a domain name in a network performed at the controller 203 as mentioned above. As shown in FIG. 3, at step S301, at the controller 203 associated with a switch 202, a DNS request for a network domain name initiated from a client 201 is received from the client 202, the controller controlling operations of the switch in the network.

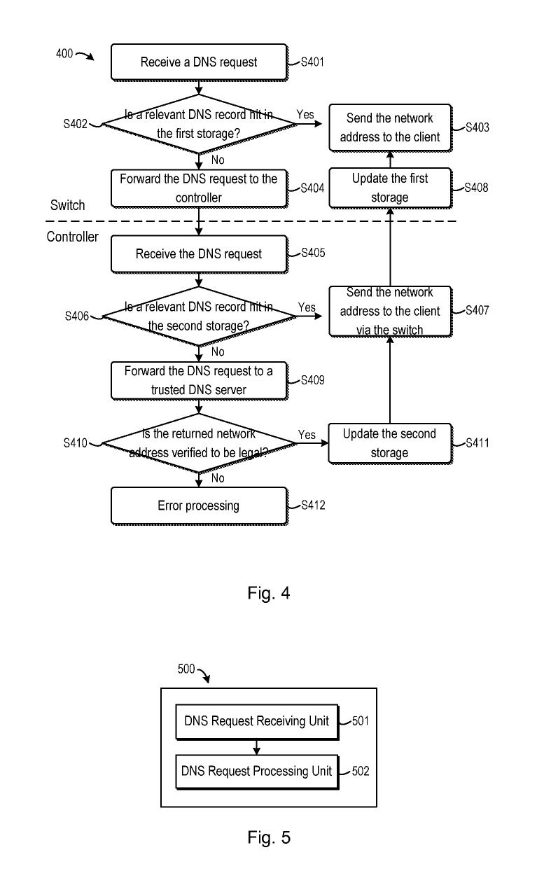

Next, at step S302, processing of the DNS request is controlled based on one or more security constraints predefined at the controller 203, to obtain a network address corresponding to the domain name. By way of example, the security constraints can comprise one or more of the first, second, third, and fourth security constraints as depicted above with reference to FIG. 2. In other words, these security constraints can be used separately or in combination in any appropriate manner. In particular, FIG. 4 shows an example of using the above four security constraints simultaneously.

Specifically, FIG. 4 shows a flow diagram of a method 400 for controlling domain name resolution according to one embodiment of the present invention. In the method 400, at step S401, the switch 202 receives a DNS request from a client 201. As a response, a relevant DNS record is searched in first storage of the switch 202. If a relevant record is found, branch “Yes”, at step S403, a network address corresponding to the requested domain name, which network address is indicated in the DNS record, is returned to the client 201. Otherwise, if the relevant DNS record is missed in the first storage 205. branch “No”, at step S202, the switch forwards the DNS request to an associated controller 203 at step S404.

The controller 203 receives the DNS request forwarded by the switch 202 at step S405, and searches a DNS record related to the DNS request in the second storage 206 at step S406. In particular, what is stored in the second storage 206 can be a verified legal DNS record, the first security constraint. Moreover, although not shown in FIG. 4, the controller 203 can continuously or periodically detect whether one or more predefined initiative update conditions are satisfied, and correspondingly update the second storage 206 initiatively, the second security constraint.

If a relevant DNS record is hit in the second storage 206, branch “Yes”, the method proceeds to step S407. Here, based on the DNS record that is hit in the second storage 206, the network address corresponding to the requested domain name is sent to the switch 202, and the switch 202 is instructed to send the network address to the client 201. As a response, the switch 202 updates the first storage 205 at step S408. Specifically, the switch 202 creates, in the first storage 205, a DNS record associating the requested network domain name and the returned network address. Next, at step S403, the switch 202 returns the network address to the client 201.

On the contrary, if a relevant DNS record is missed in the second storage 206 at step S406, branch “No”, the method 400 proceeds to step S409, where the DNS request is forwarded to the trusted DNS server 204, the third security constraint. Afterwards, at step S410, the controller performs verification regarding the legality of the returned network address, the fourth security constraint. As mentioned above, the DNS server 204 can return the network address to the switch 202 and/or controller 203. It can be seen that in the embodiment shown in method 400, although the DNS request is only forwarded to the trusted DNS server 204, the controller 203 still verifies the returned resulting network address. This helps to further enhance the security of the domain name resolution procedure.

If it is determined at step S410 that the network address is illegal, branch “Yes”, the method 400 proceeds to step S411. Here, a new DNS entry is created in the second storage 206 to update the cache. The method then proceeds to step S407, where the switch 202 is instructed to return the network address to the client 201. In particular, if the DNS server 204 returns the network address to the switch 202, then at step S407, it is only required to instruct the switch to send the returned network address to the client 201. Alternatively, if the DNS server 204 returns the network address to the controller 203, at step S407, it is also required to first forward the network address to the switch 202.

On the other hand, if it is determined that the network address at step S410 is illegal, branch “No”, then the controller 203 performs an error processing at step S412. The error processing, for example, can be discarding the returned illegal network address, and/or identifying the DNS providing the network address as untrusted DNS, etc.

It can be appreciated that in method 400, steps S401-S404 and S408 can be performed by the switch 202, while other steps are performed by the controller 203. Implementation of the method 400 can effectively handle various potential attacks during the domain name resolution procedure and greatly enhance the performing efficiency.

FIG. 5 shows a block diagram of an apparatus 500 for resolving a domain name in a network according to one embodiment of the present invention. As shown in the figure, the apparatus 500 includes: a DNS request receiving unit 501 configured to receive, at a controller associated with a switch in the network, a DNS request for the domain name from the switch, the DNS request initiated by a client, the controller controlling operations of the switch in the network; and a DNS request processing unit 502 configured to control processing of the DNS request based on a predefined security constraint at the controller to obtain a network address corresponding to the domain name, wherein the DNS request is forwarded by the switch to the controller in response to a DNS record related to the domain name being missed in first storage at the switch.

Specifically, according to the embodiments of the present invention, the DNS request can be forwarded by the switch to the controller in response to a DNS record related to the domain name being missed in first storage at the switch.

In some embodiments, the DNS request processing unit 502 can include: a DNS cache searching unit configured to search second storage at the controller for a DNS record related to the domain name, the security constraint specifying that the second storage is used to cache legal DNS records. In some embodiments, the DNS request processing unit 502 can further comprise: a DNS cache managing unit configured to determine whether at least one DNS record in the legal DNS records in the second storage has been poisoned; and a DNS cache update unit configured to, in response to determining that the at least one DNS record has been poisoned, remove the poisoned at least one DNS record.

Alternatively or additionally, in some embodiments, the DNS request processing unit 502 can comprise: a DNS request forwarding control unit configured to, in response to the DNS record related to the domain name being not found in the second storage, causing the DNS request to be forwarded to a trusted DNS server in the network to determine the network address corresponding to the domain name.

Alternatively or additionally, in some embodiments, a network address corresponding to the requested domain name is returned by the DNS server in the network. Accordingly, the DNS request processing unit 502 can include: a network address verifying unit configured to verify legality of the network address returned by the DNS server; and a network address processing unit configured to process the returned network address based on the verifying of the legality. In some embodiments, the network address processing unit can comprise a legal address processing unit configured to, in response to the returned network address being verified to be legal, cause the returned network address to be sent to the client via the switch and identify the DNS server as a trusted DNS server. Alternatively or additionally, in some embodiments, the network address processing unit can comprise an illegal address processing unit configured to, in response to the returned network address being verified to be illegal, cause the returned network address to be discarded and identify the DNS server as untrusted DNS server.

In some embodiments, the controller controls the operations of the switch through a software-defined network (SDN) controller.

It should be noted that for the sake of clarity, FIG. 5 does not show optional units or sub-units included in the apparatus 500. All features and operations as described above are suitable for apparatus 500, respectively, which are therefore not detailed here. Moreover, partitioning of units or subunits in apparatus 500 is exemplary, rather than limitative, intended to describe its main functions or operations logically. A function of one unit can be implemented by a plurality of other units; on the contrary, a plurality of units can be implemented by one unit. The scope of the present invention is not limited in this aspect.

Moreover, the units included in the apparatus 500 can be implemented by various manners, including software, hardware, firmware or a random combination thereof. For example, in some embodiments, the apparatus can be implemented by software and/or firmware. Alternatively or additionally, the apparatus 500 can be implemented partially or completely based on hardware. for example, one or more units in the apparatus 500 can be implemented as an integrated circuit (IC) chip, an application-specific integrated circuit (ASIC), a system on chip (SOC), a field programmable gate array (FPGA), etc. The scope of the present intention is not limited to this aspect.

The present invention can be a system, a method, and/or a computer program product. The computer program product can include a computer readable storage medium, or media, having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media, for example, light pulses passing through a fiber-optic cable, or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer, for example, through the Internet using an Internet Service Provider. In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I/we claim:

1. A method for resolving a domain name in a network, comprising:
receiving, at a controller associated with a switch in the network, a domain name system (DNS) request for the domain name from the switch, the DNS request initiated by a client, the controller controlling operations of the switch in the network; and
controlling processing of the DNS request based on a predefined security constraint at the controller to obtain a network address corresponding to the domain name,
wherein the DNS request is forwarded by the switch to the controller in response to a DNS record related to the domain name being missed in first storage at the switch.

2. The method according to claim 1, wherein controlling processing of the DNS request based on a predefined security constraint at the controller comprises:
searching second storage at the controller for a DNS record related to the domain name, the security constraint specifying that the second storage is used to cache legal DNS records.

3. The method according to claim 2, wherein controlling processing of the DNS request based on a predefined security constraint at the controller further comprises:
determining whether at least one DNS record in the legal DNS records in the second storage has been poisoned; and
in response to determining that at least one DNS record has been poisoned, removing the at least one poisoned DNS record.

4. The method according to claim 2, wherein controlling processing of the DNS request based on a predefined security constraint at the controller comprises:
in response to the DNS record related to the domain name being not found in the second storage, causing the DNS request to be forwarded to a trusted DNS server in the network to determine the network address corresponding to the domain name.

5. The method according to claim 1, wherein the network address corresponding to the domain name is returned by the DNS server in the network, and wherein controlling processing of the DNS request based on a predefined security constraint at the controller comprises:
verifying legality of the network address returned by the DNS server; and
processing the returned network address based on the verifying of the legality.

6. The method according to claim 5, wherein processing the returned network address based on the verifying of the legality comprises:
in response to the returned network address being verified to be legal,
causing the returned network address to be sent to the client via the switch; and
identifying the DNS server as a trusted DNS server.

7. The method according to claim 5, wherein the returned network address based on the verifying of the legality comprises:
in response to the returned network address being verified to be illegal,
causing the returned network address to be discarded; and
identifying the DNS server as an untrusted DNS server.

8. An apparatus for resolving a domain name in a network, comprising:
a DNS request receiving unit configured to receive, at a controller associated with a switch in the network, a domain name system (DNS) request for the domain name from the switch, the DNS request initiated by a client, the controller controlling operations of the switch in the network; and
a DNS request processing unit configured to control processing of the DNS request based on a predefined security constraint at the controller to obtain a network address corresponding to the domain name,
wherein the DNS request is forwarded by the switch to the controller in response to a DNS record related to the domain name being missed in first storage at the switch.

9. The apparatus according to claim 8, wherein the DNS request processing unit comprises:
a DNS cache searching unit configured to search second storage at the controller for a DNS record related to the domain name, the security constraint specifying that the second storage is used to cache legal DNS records.

10. The apparatus according to claim 9, wherein the DNS request processing unit further comprises:
a DNS cache managing unit configured to determine whether at least one DNS record in the legal DNS records in the second storage has been poisoned; and
a DNS cache updating unit configured to, in response to determining that the at least one DNS record has been poisoned, remove the poisoned at least one DNS record.

11. The apparatus according to claim 9, wherein the DNS request processing unit comprises:
a DNS request forwarding control unit configured to, in response to the DNS record related to the domain name being not found in the second storage, causing the DNS request to be forwarded to a trusted DNS server in the network to determine the network address corresponding to the domain name.

12. The apparatus according to claim 8, wherein the network address corresponding to the domain name is returned by the DNS server in the network, and wherein the DNS request processing unit comprises:
a network address verifying unit configured to verify legality of the network address returned by the DNS server; and
a network address processing unit configured to process the returned network address based on the verifying of the legality.

13. The apparatus according to claim 12, wherein the network address processing unit comprises:
a legal address processing unit configured to, in response to the returned network address being verified to be legal,
cause the returned network address to be sent to the client via the switch; and
identify the DNS server as a trusted DNS server.

14. The apparatus according to claim 12, wherein the network address processing unit comprises:
an illegal address processing unit configured to, in response to the returned network address being verified to be illegal,
cause the returned network address to be discarded; and
identify the DNS server as an untrusted DNS server.

15. A system for resolving a domain name in a network, comprising:
a switch configured to receive a domain name system (DNS) request from a client;
a controller associated with the switch, configured to control operations of the switch in the network and comprising the apparatus according to claim 8; and
at least one DNS server for determining a network address corresponding to the domain name in the case of receiving the DNS request.
